(19) United States
(12) Patent Application Publication
(10) Pub. No.: US 2013/0296524 A1
(43) Pub. Date: Nov. 7, 2013

(54) APPARATUS FOR PRODUCING AROMATIC POLYESTER AND PROCESS FOR PRODUCING AROMATIC POLYESTER

(71) Applicants: Michiyoshi Matsumoto, Nagoya-shi (JP); Kunihiko Miyauchi, Iyo-gun (JP); Hideyuki Umetsu, Nagoya-shi (JP)

(72) Inventors: Michiyoshi Matsumoto, Nagoya-shi (JP); Kunihiko Miyauchi, Iyo-gun (JP); Hideyuki Umetsu, Nagoya-shi (JP)

(73) Assignee: TORAY INDUSTRIES INC, TOKYO (JP)

(21) Appl. No.: 13/996,798

(22) PCT Filed: Dec. 19, 2011
(86) PCT No.: PCT/JP2011/079301

§ 371 Date: Jun. 21, 2013

(30) Foreign Application Priority Data
Dec. 27, 2010 (JP) 2010-289988

(51) Int. Cl. B01J 19/00; C08G 63/78

(52) U.S. Cl. CPC B01J 19/0053; C08G 63/785
USPC 528/305; 422/131; 528/361; 422/138

(57) ABSTRACT

The present invention provides an apparatus for producing an aromatic polyester, comprising a reactor, a rectifying column, a distillation pipe for feeding distillate gas from the reactor to the rectifying column, and a liquid returning pipe for returning reflux liquid from the rectifying column to a reactor, wherein the ratio of (b) the inside diameter of pipe of the liquid returning pipe to (a) the maximum inside diameter of drum of the reactor, (b)/(a), is 0.012 to 0.12. The production apparatus has an efficient rectifying effect and is suitable for producing an aromatic polyester having an excellent heat resistance and color tone efficiently with good polymerizability and at low cost.

### CROSS-REFERENCE TO RELATED APPLICATIONS

This application is the U.S. National Phase application of PCT International Application No. PCT/JP2011/079301, filed Dec. 19, 2011, and claims priority to Japanese Patent Application No. 2010-289988, filed Dec. 27, 2010, the disclosures of both of which are incorporated herein by reference in their entireties for all purposes.

### TECHNICAL FIELD

The present invention relates to an apparatus for producing an aromatic polyester and a process for producing an aromatic polyester using the production apparatus.

### BACKGROUND OF THE INVENTION

In recent years, there has been an increased demand for higher-performance plastics. For polyester polymers, a number of polymers having various functions, such as polybutylene terephthalate (PBT), polyethylene-2,6-naphthalate (PEN), and the like, have been developed and introduced into the market. Among the polyester polymers, aromatic polyesters which are obtained by using an aromatic hydroxycarboxylic acid, aromatic dicarboxylic acid, and aromatic dihydroxy compound as an original monomer have received attention. In particular, thermotropic liquid crystal polyester (LCP) characterized by parallel arrangement of molecular chains have received attention because of having excellent flowability, mechanical strength, and heat resistance.

Examples of conventional methods for producing a polyester include, for example, in the case of direct polymerization of PBT, a method in which terephthalic acid and 1,4-butanediol are first allowed to react in the presence of an esterification reaction catalyst such as a titanium compound. In this method, an esterification reaction is carried out in such a manner that distillate mainly composed of by-produced tetrahydrofuran and water is distilled from the head of a rectifying column placed at an esterification reactor, and then a polycondensation reaction is carry out in a polycondensation reactor to thereby obtain PBT. For example, Patent Document 1 discloses a process for stably producing PBT using the distillation process using a rectifying column with a low theoretical plate number and a low reflux ratio by providing distillate in which the content of monohydric alcohol having three or less carbon atoms contained in the distillate is not more than 40 ppm by weight based on tetrahydrofuran in the distillate.

On the other hand, aromatic polyesters are obtained by using as a main material an aromatic hydroxycarboxylic acid such as p-hydroxybenzoic acid, an aromatic dihydroxy compound such as 4,4′-dihydroxybiphenyl, an aromatic dicarboxylic acid such as terephthalic acid, and further an aliphatic polyester such as polyethylene terephthalate (PET). A common process for producing an aromatic polyester is a process in which phenolic hydroxyl groups in materials are first acylated with fatty acid anhydride such as acetic anhydride, or alternatively an fatty acid ester of phenolic hydroxyl groups is used as a material, and then polymerization is carried out under heating (optionally under decompression) while removing fatty acid by-produced in the acylation and/or fatty acid produced by transesterification by distillation. For example, Patent Document 2 discloses an aromatic copolyester having excellent melt flowability, optical anisotropy, and mechanical properties at the same time obtained by melt polymerization only. The process for producing this aromatic copolyester is acylation using acetic anhydride and deacetylation polycondensation.

However, such processes for producing an aromatic polyester have a problem in that aromatic hydroxycarboxylic acid, aromatic dihydroxy compound, or fatty acid esters thereof (hereinafter referred to as original monomers and acylated products thereof) distills and volatilizes together with distilling fatty acid. As a result, suffocation of polymerization due to a differed molar ratio of acyl groups to carboxyl groups occurs, and problems occur; for example, polymerization time is delayed; a polymerization product with a desired viscosity cannot be obtained; a polymer is colored; or unit consumption of original monomers increases. In addition, original monomers and acylated products thereof precipitate in a distillation pipe or a condenser to cause blocking, whereby production of an aromatic polyester itself would be difficult. Thus, various countermeasures have been proposed in order to solve these problems.

Patent Document 3 discloses a method in which some of distilling fatty acid are refluxed to a reactor and describes that, as a means therefor, a double-tube type internal reflux column equipped with a baffle plate or a double-tube type internal reflux column without a baffle plate can be used. This is because raw materials as a main material for LCP or the like having a melting point of 80° C. or higher are generally used , therefore the vapor pressure (sublimation pressure) is low although distilling fatty acid is generally acetic acid, propionic acid, butyric acid, or the like which has a relatively high vapor pressure, and one vapor-liquid contact provides a sufficient rectifying effect.

Further, Patent Document 4 discloses a method in which, in producing an aromatic polyester batchwise by polycondensation of materials for aromatic polyester at a final reaction temperature in the range of 300 to 400° C., the temperature of the part of a reaction apparatus in contact with a reaction space above the liquid level of a reaction solution is maintained at 150 to 300° C., and further a distillation pipe has a reflux column and a nozzle protruding into a reactor, whereby a reflux liquid drops into a reaction mixture without flowing down the inner wall of the reactor.

Further, Patent Documents 5, 6, and 7 disclose a method in which polycondensation is carried out using a polycondensation reactor with a partial condenser comprising a tube type heat exchanger while distillate is partially condensed and condensate is recovered into a polycondensation reactor, and an aromatic polyester is produced. The respective documents further disclose a method using a corrosion resistant material for the partial condenser (Patent Document 5), a method in which the temperature of refrigerant of the partial condenser is controlled at or lower than the boiling point of a low-boiling substance that distills from the polycondensation reactor (Patent Document 6), or a method in which the temperature of a heating medium supplied to the partial condenser is controlled such that the temperature of a low-boiling substance distilled from the partial condenser is in the range of 115° C. to 145° C. (Patent Document 7).

### PATENT DOCUMENTS

Patent Document 1: JP 2002-138141 A (Claims, Figures)
Patent Document 2: JP 4-136027 A (Claims)
Patent Document 3: JP 1993-271398 A (Claims, Figures)
Patent Document 4: WO 2003/062299 (Claims, Figures)
Patent Document 5: JP 2004-331829 A (Claims, Figures)
Patent Document 6: JP 2006-307006 A (Claims, Figures)
Patent Document 7: JP 2006-299027 A (Claims, Figures)

### SUMMARY OF THE INVENTION

In the conventional methods, only one distillation pipe is used as a pipe connecting a reactor and a rectifying column in many cases. Therefore, distillate gas and a refluxed returning liquid are countercurrent in the pipe, causing an increased internal pressure. Further, when a liquid volume or distillate gas volume is increased, a loading or flooding phenomenon occurs and significantly decreases distillation efficiency, resulting in suffocation of polymerization. These problems can be solved by increasing the pipe size. However, when producing an aromatic polyester by liquid phase polymerization, in some cases, a valve is placed on a pipe at the upper part of a reactor, and when discharging from the reactor, the valve is closed and the pressure is increased with nitrogen or the like to thereby make the discharge of polymers efficient. If the size of the distillation pipe is increased, the size of a corrosion resistant valve which uses expensive materials would also be increased and the equipment cost would also be increased.

Further, there is another conventional method in which both a distillation pipe for feeding distillate gas from a reactor to a rectifying column and a liquid returning pipe for returning reflux liquid from the rectifying column to a reactor are provided. However, in this method, similarly to the rectifying column of an ester reactor in the cases of PET, PBT, and the like, distillation in which theoretical number is three or more and a reflux ratio is 1 or more, is generally assumed. Therefore the pipe size get also large, the pipe and valve made of expensive corrosion resistant materials should be provided, and the equipment cost would also be increased.

The present inventors studied in order to solve the problems described above to conclude that the vapor pressure of accompanying original monomers is extremely low compared to the vapor pressure of fatty acid that distills when producing an aromatic polyester, which allows sufficient isolation with both a theoretical plate number and a reflux ratio of less than 1. Paying attention to this conclusion, the present inventors discovered that, by providing both a distillation pipe for feeding distillate gas from the reactor to the rectifying column and a liquid returning pipe for returning reflux liquid from the rectifying column to a reactor and besides limiting the ratio of the inside diameter of pipe of the liquid returning pipe to the maximum inside diameter of drum of the reactor in a certain range, distillation of fatty acid is not inhibited; valves with a versatile size can be placed; and an efficient and inexpensive apparatus for producing an aromatic polyester can be obtained.

Thus the present invention provides an apparatus for producing an aromatic polyester, comprising a reactor, a rectifying column, a distillation pipe for feeding distillate gas from the reactor to the rectifying column, and a liquid returning pipe for returning reflux liquid from the rectifying column to the reactor, wherein the ratio of (b) the inside diameter of pipe of the liquid returning pipe to (a) the maximum inside diameter of drum of the reactor, (b)/(a), is 0.012 to 0.12.

The present invention also provides a process for producing an aromatic polyester, comprising carrying out an acetylation reaction using the apparatus according to the present invention for producing an aromatic polyester, and then carrying out a polymerization reaction.

The present invention provides a production apparatus and production process by which an aromatic polyester having an excellent heat resistance and color tone can be produced efficiently with good polymerizability and at low cost.

### BRIEF DESCRIPTION OF THE DRAWINGS

FIG. 1 is a conceptual diagram showing an example of the apparatus for producing an aromatic polyester according to the present invention.

### DETAILED DESCRIPTION OF EMBODIMENTS OF THE INVENTION

The apparatus for producing an aromatic polyester according to an embodiment of the present invention will now be described.

### [Aromatic Polyester]

Examples of the aromatic polyester in the present invention include an aromatic hydroxycarboxylic acid, aromatic dihydroxy compound, aromatic dicarboxylic acid, polyester composed of dioxy units and dicarbonyl units, aromatic amino hydroxy compound, aromatic amino carboxylic acid, derivatives thereof, and the like. In particular, an aromatic polyester composed of materials including at least one selected from aromatic hydroxycarboxylic acids, aromatic dihydroxy compounds, and aromatic dicarboxylic acids is preferably used. More preferred is an aromatic liquid-crystalline polyester composed of such an appropriately combined composition that the polymer shows liquid crystallinity.

Examples of the aromatic hydroxycarboxylic acid described above include p-hydroxybenzoic acid, 6-hydroxy-2-naphthoic acid, and the like.

Examples of the aromatic dihydroxy compound include 4,4′-dihydroxybiphenyl, hydroquinone, 3,3′,5,5′-tetramethyl-4,4′-dihydroxybiphenyl, t-butylhydroquinone, phenylhydroquinone, methylhydroquinone, 2,6-dihydroxynaphthalene, 2,7-dihydroxynaphthalene, 2,2-bis(4-hydroxyphenyl)propane, 4,4′-dihydroxydiphenyl ether, and the like.

Examples of the aromatic dicarboxylic acid include terephthalic acid, isophthalic acid, 4,4′-diphenyldicarboxylic acid, 2,6-naphthalene dicarboxylic acid, 1,2-bis(phenoxy)ethane-4,4′-dicarboxylic acid, 1,2-bis(2-chlorphenoxy)ethane-4,4′-dicarboxylic acid, diphenyl ether dicarboxylic acid, and the like.

Examples of polyesters composed of dioxy units and dicarbonyl units include polyethylene terephthalate or oligomers thereof.

An aromatic hydroxycarboxylic acid or derivatives thereof, a dihydroxy compound or derivatives thereof, and an aromatic dicarboxylic acid or derivatives thereof that constitute a structural unit of an aromatic liquid-crystalline polyester and can be a raw material are solid at normal temperature in many cases, and these are preferably used as a powder. Further, polyesters composed of dioxy units and dicarbonyl units are solid at normal temperature but generally used as a pellet or a powder obtained by grinding the pellet.

### [Reaction]

In an embodiment of the present invention, the reactions for producing an aromatic polyester are a reaction in which aromatic hydroxyl groups are acylated and a reaction in which de-fatty acid polymerization is performed. In this case, there are cases where de-fatty acid polymerization is performed using a raw material in which hydroxyl groups are acylated in advance and where, using a hydroxyl group-containing monomer as a raw material that will constitute an aromatic polyester together with an acylating agent, an acylation reaction in which hydroxyl groups are acylated and a de-fatty acid melt polymerization reaction are performed. Of these two, the latter method is preferred. As a de-fatty acid polymerization, for example, deacetylation polymerization can be performed in a molten state to produce an aromatic polyester.

The acylating agent used in the present invention is preferably an acylating agent that can be liquid in the range of 120° C. or lower. Specifically, acetic anhydride is preferred.

Specific examples of the process for producing an aromatic polyester include a process in which, using, for example, a hydroxyl group-containing compound, a carboxylic acid group-containing compound, and an acylating agent such as acetic anhydride, hydroxyl groups are acylated, and then deacetylation polycondensation is performed in a molten state, this process in which a compound obtained by acylating a portion of the hydroxyl group-containing compound is used alternatively, and the like. In particular, such a process as exemplified by (1) or (2) below is preferred.

(1) A process in which an aromatic hydroxycarboxylic acid such as p-hydroxybenzoic acid, an aromatic dihydroxy compound such as 4,4′-dihydroxybiphenyl or hydroquinone, and an aromatic dicarboxylic acid such as terephthalic acid or isophthalic acid are reacted with acetic anhydride to acylate phenolic hydroxyl groups, and then an aromatic polyester is produced by a deacetylation polycondensation reaction in a molten state.

(2) A process for producing an aromatic polyester by the process (1) in the presence of polymer of polyester such as polyethylene terephthalate, oligomer of the polyester or bis(β-hydroxyethyl) ester of an aromatic dicarboxylic acid such as bis(β-hydroxyethyl)terephthalate.

Further, for specific conditions in the production process (1) or (2) described above, the amount of acetic anhydride is preferably 1.0-fold to 1.5-fold molar excess of the hydroxyl groups in starting raw materials. In particular, it is preferably 1.05-fold to 1.2-fold molar excess.

An example of reaction temperature and polymerization time of the production process described above will be given. The starting raw materials as shown above are charged into a reaction system, and an acetylation reaction is carried out under normal pressure or increased pressure at a temperature of normal temperature to 230° C. for 5 minutes to 3 hours. The temperature of the acetylation reaction is preferably 100° C. to 200° C. and more preferably 130° C. to 180° C. The time of the acetylation reaction is preferably 10 minutes to 2 hours. After the acetylation reaction, the temperature is raised to 230° C. to 350° C., and an initial polymerization reaction accompanied by deacetylation is performed. The initial polymerization reaction is carried out at normal pressure, and the temperature is preferably 250° C. to 350° C. The initial polymerization time is preferably less than 10 hours in the case of a batch reaction. If the initial polymerization time is not less than 10 hours, the total polymerization cycle will be 12 hours or more, reducing the production efficiency. Then, while raising the temperature to 230° C. to 370° C., a deacetylation polycondensation is performed in a molten state under decompression. The temperature of the deacetylation polycondensation is preferably 250° C. to 350° C. By this process, a more preferred aromatic polyester can be obtained.

Although such a polycondensation reaction proceeds without a catalyst, it is sometimes preferred (i) to add as a catalyst a metal compound such as stannous acetate, tetrabutyl titanate, potassium acetate and sodium acetate, antimony trioxide, or magnesium metal or (ii) to add a compound such as sodium hypophosphite or potassium hypophosphite which is effective as a catalyst and color tone improver. When such a catalyst and an additive are added, it is preferable to add (i) in an amount of 0.001 part by mass to 1 part by mass and (ii) in an amount of 0.001 part by mass to 5 parts by mass, based on 100 parts by mass of a liquid-crystalline resin.

### [Production Apparatus]

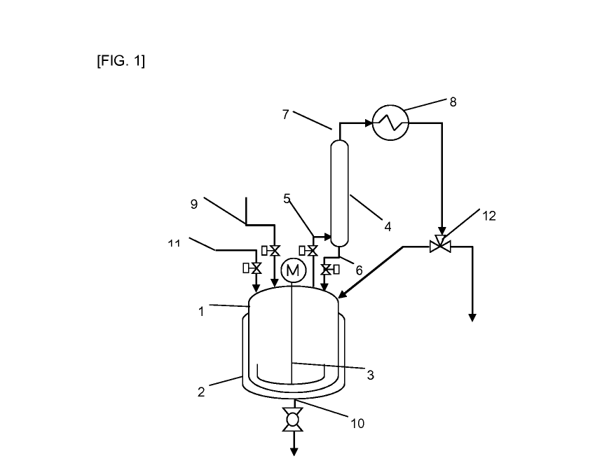

The apparatus for producing an aromatic polyester according to an embodiment of the present invention at least comprises a reactor, a rectifying column, a distillation pipe for feeding distillate gas from a reactor to the rectifying column, and a liquid returning pipe for returning reflux liquid from the rectifying column to the reactor. A specific example of this production apparatus is shown in FIG. 1. The production apparatus of FIG. 1 comprises a reactor 1, a heating medium jacket for heating 2, a stirring blade 3, a rectifying column 4, a distillation pipe 5 for feeding distillate gas from the reactor to the rectifying column, a liquid returning pipe 6 for returning reflux liquid from the rectifying column to the reactor, a distillation pipe 7 from the rectifying column, a condenser (total condenser) 8, a charge port 9, and a discharge port 10. Further, it also comprises, if necessary, a gas supply port 11 which allows purge and pressurization using nitrogen or the like and valves to each pipe. Further, it also comprises, if necessary, a three-way valve 12 and pipes for feeding distillate gas coming from the rectifying column to the reactor or out of the system. Furthermore, if necessary, the reactor may be divided into a pre-reactor and a post-reactor, and the post-reactor may be equipped with incidental equipment for decompression such as a vacuum pump and an ejector to promote polycondensation under decompression. The production apparatus may be a batch production apparatus or a continuous production apparatus.

In the apparatus for producing an aromatic polyester according to an embodiment of the present invention, the ratio of (b) the inside diameter of pipe of the liquid returning pipe to (a) the maximum inside diameter of drum of the reactor, (b)/(a), is 0.012 to 0.12. When (b)/(a) is smaller than 0.012, a reflux liquid does not return smoothly, and holdup of the liquid increases in the rectifying column to cause loading or flooding, impairing the rectifying effect. When (b)/(a) is larger than 0.12, large-sized pipes and large-sized valves of corrosion resistant material are required, increasing the equipment cost. To smoothly return the reflux liquid to the reactor, the lower limit of (b)/(a) is preferably not less than 0.02 and more preferably not less than 0.03. From the standpoint of reducing the equipment cost by using a thin liquid returning pipe, the upper limit of (b)/(a) is preferably not more than 0.1 and more preferably not more than 0.08.

Further, to smoothen the flow of distillate gas and suppress the increase of internal pressure of the reactor, the ratio of (c) the inside diameter of pipe of the distillation pipe to (b) the inside diameter of pipe of the liquid returning pipe, (c)/(b), is preferably 1.1 or more. More preferably, (c)/(b) is 1.3 or more, and, still more preferably, (c)/(b) is 1.5 or more. The larger the ratio of (c)/(b), the smoother the flow of distillate gas; thus the upper limit of the ratio of (c)/(b) need not be particularly defined, but the practical upper limit is 10 or less in view of the size of a pipe that can be placed.

The material of the production equipment of the present invention is preferably corrosion-resistant to an acetylation reaction solution and the like. Specific examples thereof include SUS316, SUS316L, SUS836L, SUS904L, duplex stainless, nickel-molybdenum alloy, impervious graphite, titanium, zirconium, GL, tantalum, and the like.

### [Rectifying Column]

Specific examples of the rectifying column 4 in the present invention that is preferably used include an internal reflux column that exteriorly has a jacket through which refrigerant passes and is selected from a single tube equipped with a baffle plate, a packed column, and a tray column. The reason for having a jacket through which refrigerant passes is that, as a method of generating internal reflux by cooling, expressing a rectifying effect, and distilling acetic acid efficiently while preventing dispersion of original monomers and an acylated product thereof, the method of controlling the head temperature is preferably used. More specifically, when acetic anhydride is used as an acylating agent, the method of controlling the head temperature at 110° C. to 150° C. is preferably used.

In the case of the aromatic polyester in the present invention, the vapor pressure of accompanying original monomers is extremely low compared to the vapor pressure of fatty acid that distills in the production, which allows sufficient isolation with both a theoretical plate number and a reflux ratio of less than 1. Therefore, for the height and column diameter of the rectifying column, although depending on gas distillation rate and internal structure, it is preferable to place the rectifying column on the assumption that the rectifying column is operated with a theoretical plate number and a reflux ratio both being up to 1 as a standard.

### [Production Process]

The process for producing an aromatic polyester according to an embodiment of the present invention is a process comprising carrying out an acetylation reaction using the above-mentioned apparatus for producing an aromatic polyester having a reactor and a rectifying column, and then carrying out a polymerization reaction. By using this process, distillation of fatty acid is not inhibited; valves with a versatile size can be placed; and an aromatic polyester having an excellent heat resistance and color tone can be obtained efficiently with good polymerizability and at low cost.

### [Applications]

Into an aromatic polyester obtained using the production apparatus of the present invention, inorganic fillers are incorporated as required, whereby an aromatic polyester resin composition can be obtained. Examples of inorganic fillers that can be used include, but are not particularly limited to, fibrous fillers, plate-like fillers, powder fillers, granular fillers, and the like. Specific examples thereof include, for example, glass fibers, PAN-based or pitch-based carbon fibers, metal fibers such as stainless fibers, aluminum fibers, and brass fibers, organic fibers such as aromatic polyamide fibers, gypsum fibers, ceramic fibers, asbestos fibers, zirconia fibers, alumina fibers, silica fibers, titanium oxide fibers, silicon carbide fibers, and the like.

Into an aromatic polyester obtained using the production apparatus of the present invention, antioxidants and heat stabilizers (e.g., hindered phenol, hydroquinone, phosphites, substitution products thereof, and the like), UV absorbers (e.g., resorcinol, salicylate, benzotriazole, benzophenone, and the like), lubricants and mold releasing agents (montanic acid, salts thereof, esters thereof, and half-esters thereof, stearyl alcohol, stearamide, polyethylene wax, and the like), coloring agents including dyes (e.g., nigrosine and the like) and pigments (e.g., cadmium sulfide, phthalocyanine, and the like), crystalline nucleus agents, plasticizing agents, flame retardants, and the like are incorporated as required, whereby an aromatic polyester resin composition can be obtained.

As a method of incorporating them, melt-kneading is preferred. A known method can be used for melt-kneading. For example, the composition can be obtained by melt-kneading at a temperature of 180° C. to 370° C. using a Banbury mixer, rubber roller, kneader, single- or twin-screw extruder, or the like.

The aromatic polyester resin composition thus obtained can be molded by a usual molding method such as injection molding, extrusion molding, and compression molding. This molded product can be processed into a three-dimensional molded article, a sheet, a container pipe, and the like because it has excellent mechanical strength, heat resistance, and hydrolysis resistance, and is extremely useful for electric and electronic parts, precision parts, automotive parts, and the like. Specifically, the molded product can be widely used as parts of various gears, various cases, sensors, LED lamps, connectors, sockets, resistors, relay case, switch, coil bobbins, condensers, variable condenser cases, optical pickups, radiators, various terminal boards, transformers, plugs, printed wiring boards, tuners, speakers, microphones, headphones, small motors, magnetic head bases, power modules, housings, semiconductors, and the like. Further, because of the excellent color tone, an excellent colored molded article can be provided by adding a coloring agent.

### EXAMPLES

The apparatus and process for producing an aromatic polyester will now be described specifically by way of example. However, the present invention is not limited to these examples.

### Example 1

The production equipment shown in FIG. 1 was used. This production equipment comprises a heating medium jacket for heating, a reactor (inside diameter of drum (a): 1500 mm, volume: 3 m³) having a stirring blade, a rectifying column (a single tube inside which a baffle plate is placed and which is equipped with a water cooling jacket, column diameter: 200 mm, height: 3000 mm. Hereinafter, referred to as a rectifying column A), a distillation pipe for feeding distillate gas from the reactor to the rectifying column (inside diameter of pipe (c): 125 mm, having a valve), a liquid returning pipe for returning reflux liquid from the rectifying column to a reactor (inside diameter of pipe (b): 80 mm, having a valve), and a condenser (total condenser). Into the reactor, 795 Kg of p-hydroxybenzoic acid, 271 Kg of 6-hydroxy-2-naphthoic acid, and 772 Kg of acetic anhydride were charged and allowed to react at 145° C. for 2 hours with stirring under a nitrogen gas atmosphere. All the distillate cooled in the condenser during this time was returned to the reactor. Next, under normal pressure, the temperature was raised to 330° C. over 6 hours, and while maintaining the head temperature at 150° C. or lower by passing cooling water to the rectifying column, all the distillate was distilled out of the system. Thereafter, the pressure was reduced to 133 Pa over 2 hours while further maintaining the polymerization temperature at 330° C., and the reaction was further continued for 30 minutes, after which the polycondensation was completed. Then, each valve was closed, and the pressure in the reaction vessel was increased to 0.1 MPa with nitrogen. A polymer was discharged in the form of a strand via a die having a plurality of circular discharge ports with a diameter of 3 mm and pelletized with a cutter.

This aromatic polyester had a Tm (melting point) of 320° C. and a melt viscosity of 20 Pa·s. The melt viscosity is a value measured using a Koka-type flow tester (orifice: 0.5φ×10 mm) at a temperature of 330° C., a residence time of 5 min, and a shear rate of 1000/s.

### Example 2

Production equipment comprising the same apparatus as in Example 1 except that the rectifying column A was changed to a rectifying column B (a packed column into which a ½-inch Raschig ring is loaded and which is equipped with a water cooling jacket, column diameter: 300 mm, height: 2500 mm) was used. Into the reactor, 763 Kg of p-hydroxybenzoic acid, 129 Kg of 4,4′-dihydroxybiphenyl, 115 kg of terephthalic acid, 133 Kg of polyethylene terephthalate with a intrinsic viscosity of about 0.6 dl/g, and 775 Kg of acetic anhydride were charged and allowed to react at 145° C. for 2 hours with stirring under a nitrogen gas atmosphere. All the distillate cooled in the condenser during this time was returned to the reactor. Next, under normal pressure, the temperature was raised to 330° C. over 6 hours, and while maintaining the head temperature at 150° C. or lower by passing cooling water to the rectifying column, all the distillate was distilled out of the system. Thereafter, the pressure was reduced to 133 Pa over 2 hours while further maintaining the polymerization temperature at 330° C., and the reaction was further continued for 30 minutes, after which the polycondensation was completed. Then, each valve was closed, and the pressure in the reaction vessel was increased to 0.1 MPa with nitrogen. A polymer was discharged in the form of a strand via a die having a plurality of circular discharge ports with a diameter of 3 mm and pelletized with a cutter.

The aromatic polyester produced had a Tm (melting point) of 326° C. and a melt viscosity of 13 Pa·s. The melt viscosity is a value measured using a Koka-type flow tester (orifice: 0.5φ×10 mm) at a temperature of 330° C., a residence time of 5 min, and a shear rate of 1000/s.

### Example 3

Polycondensation and pelletization were carried out using the same apparatus and the same conditions as in Example 2 except that the liquid returning pipe was changed to a liquid returning pipe with an inside diameter of pipe (b) of 25 mm having a valve.

The aromatic polyester produced had a Tm (melting point) of 326° C. and a melt viscosity of 14 Pa·s. The melt viscosity is a value measured using a Koka-type flow tester (orifice: 0.5φ×10 mm) at a temperature of 330° C., a residence time of 5 min, and a shear rate of 1000/s.

### Example 4

Polymerization was carried out using the same apparatus as in Example 1 except that the distillation pipe was changed to a distillation pipe with an inside diameter of pipe (c) of 80 mm having a valve. It took 8 hours to raise the temperature to 330° C. Thereafter, polycondensation under reduced pressure, discharge, and pelletization were carried out under the same conditions.

The aromatic polyester produced had a Tm (melting point) of 320° C., and the melt viscosity measured using a Koka-type flow tester (orifice: 0.5φ×10 mm) at a temperature of 330° C., a residence time of 5 min, and a shear rate of 1000/s was 20 Pa·s.

### Comparative Example 1

Although polymerization was carried out using the same apparatus as in Example 1 except that the reactor and the rectifying column were connected by one pipe with an inside diameter of pipe of 80 mm, it took 12 hours to raise the temperature to 330° C., resulting in decreased polymerizability. Thereafter, polycondensation under reduced pressure, discharge, and pelletization were carried out under the same conditions. Although the total equipment cost of the pipe and valve decreased because the number of pipe connecting the reactor with the rectifying column was one, the aromatic polyester produced had a deteriorated liver-brown color tone, a decreased Tm (melting point) of 317° C., and a decreased melt viscosity of 15 Pa·s. The melt viscosity is a value measured using a Koka-type flow tester (orifice: 0.5φ×10 mm) at a temperature of 330° C., a residence time of 5 min, and a shear rate of 1000/s. A large amount of white precipitate was observed in a tube condenser after completion.

### Comparative Example 2

Polycondensation and pelletization were carried out using the same apparatus and the same conditions as in Example 2 except that the distillation pipe was changed to a distillation pipe with an inside diameter of pipe (c) of 250 mm having a valve and the liquid returning pipe was changed to a liquid returning pipe with an inside diameter of pipe (b) of 250 mm having a valve.

The aromatic polyester produced had a Tm (melting point) of 326° C. and a melt viscosity of 13 Pa·s. The melt viscosity is a value measured using a Koka-type flow tester (orifice: 0.5φ×10 mm) at a temperature of 330° C., a residence time of 5 min, and a shear rate of 1000/s.

### Comparative Example 3

Although polymerization was carried out using the same apparatus as in Example 2 except that the distillation pipe was changed to a distillation pipe with an inside diameter of pipe (c) of 100 mm having a valve and the liquid returning pipe was changed to a liquid returning pipe with a pipe diameter (b) of 15 mm having a valve, it took 10 hours to raise the temperature to 330° C., resulting in decreased polymerizability. Thereafter, polycondensation under reduced pressure, discharge, and pelletization were carried out under the same conditions.

The aromatic polyester produced had a deteriorated liver-brown color tone, a decreased Tm (melting point) of 318° C., and a decreased melt viscosity of 10 Pa·s. The melt viscosity is a value measured using a Koka-type flow tester (orifice: 0.5φ×10 mm) at a temperature of 330° C., a residence time of 5 min, and a shear rate of 1000/s.

The pellets obtained in Examples 1 to 4 and Comparative Examples 1 to 3 were evaluated for heat resistance and color tone.

### (Heat Resistance)

The pellet obtained was held for 30 minutes at the same temperature as in the viscosity measurements at a residence time of 5 minutes using a Koka-type flow tester (orifice: 0.5φ×10 mm) to measure melt viscosity, and the viscosity retention during the residence was evaluated by the following equation. The melt viscosity at a residence of 5 minutes is shown in each Example and Comparative Example.

Viscosity retention=(Melt viscosity at a residence time of 30 minutes/Melt viscosity at a residence of 5 minutes)×100 (%).

### (Color Tone)

The brightness (L value) of the pellet obtained was measured using a SM color computer apparatus manufactured by Suga tester.

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Raw | HBA | ∘ | ∘ | ∘ | ∘ | ∘ | ∘ | ∘ |
| material | HNA | ∘ | | | ∘ | ∘ | | |
| | DHB | | ∘ | ∘ | | | ∘ | ∘ |
| | TPA | | ∘ | ∘ | | | ∘ | ∘ |
| | PET | | ∘ | ∘ | | | ∘ | ∘ |

| | | | | | | | |
|---|---|---|---|---|---|---|---|
| Rectifying Column | Rectifying | Rectifying | Rectifying | Rectifying | Rectifying | Rectifying | Rectifying |
| | column A | column B | column B | column A | column A | column B | column B |
| (a) Maximum Inside Diameter of Drum of Reactor (mm) | 1500 | 1500 | 1500 | 1500 | 1500 | 1500 | 1500 |
| (b) Inside Diameter of Pipe of Liquid Returning Pipe (mm) | 80 | 80 | 25 | 80 | — | 250 | 15 |
| (c) Inside Diameter of Pipe of Distillation Pipe (mm) | 125 | 125 | 125 | 80 | 80 | 250 | 100 |
| (b)/(a) Ratio of Inside Diameter of Pipe/Inside Diameter | 0.053 | 0.053 | 0.017 | 0.053 | — | 0.167 | 0.010 |
| of Drum | | | | | | | |
| (c)/(b) Ratio of Inside Diameters of Pipe | 1.6 | 1.6 | 5.0 | 1.0 | — | 1.0 | 6.7 |
| Initial Polymerization Reaction Time Until The Inner | 6 | 6 | 6 | 8 | 12 | 6 | 10 |
| Temperature of 330° C. (hr) | | | | | | | |
| Melting Point, Tm (° C.) | 320 | 326 | 326 | 320 | 317 | 326 | 318 |
| Viscosity (5-minute Residence) (Pa · s) | 20 | 13 | 14 | 20 | 15 | 13 | 10 |
| Viscosity Retention During Residence (%) | 95 | 93 | 93 | 95 | 85 | 93 | 87 |
| Color Tone (L Value) | 50 | 48 | 47 | 49 | 40 | 48 | 42 |
| Equipment Cost (Sum of Cost of Pipes and Cost of Valves) | Low cost | Low cost | Low cost | Low cost | Lowest cost | High cost | Low cost |

HBA: p-hydroxybenzoic acid
HNA: 6-hydroxy-2-naphthoic acid
DHB: 4,4′-dihydroxybiphenyl
TPA: Terephthalic acid
PET: Polyethylene terephthalate
The mark “∘” in the table means that the raw material was used.

In Examples 1 to 4, (b)/(a) were all in the range of 0.012 to 0.12, and, therefore, the aromatic polyester produced had an excellent heat resistance and color tone. The aromatic polyester was produced efficiently in a short initial polymerization reaction time. The equipment cost was low. Also, the aromatic polyester was suitable as a resin composition.

In Example 2, four components were used as a raw material, but the aromatic polyester produced had an excellent heat resistance and color tone. Although the equipment cost slight increased as the rectifying column was changed to a packed column, the valve size was versatile, and the total equipment cost was low.

In Example 3, although the inner diameter of the liquid returning pipe was thinner than that in Example 2, the distillation efficiency was good, and the production could be carried out efficiently in a short initial polymerization reaction time. The aromatic polyester produced had an excellent heat resistance and color tone.

In Example 4, (c)/(b) was less than 1.1; therefore, the flow of distillate gas was slightly unsmooth, and the deacetylation polymerization time until reaching 330° C. at which distillation of acetic acid is almost finished was somewhat long.

In Comparative Example 1, although the equipment cost was lowest because of one pipe, flooding occurred in the pipe, decreasing the distillation efficiency. Further, dispersion of monomers also increased. The aromatic polyester produced had a deteriorated heat resistance, color tone, and viscosity.

In Comparative Example 2, a thicker pipe was used, and, therefore, the aromatic polyester produced had an excellent heat resistance and color tone and could be efficiently produced. However, the cost of the valves increased because the pipe was thick, and the total equipment cost increased.

In Comparative Example 3, the inner diameter of the liquid returning pipe was even thinner than that in Example 3, and, consequently, the return of the reflux liquid was not smooth, decreasing the distillation efficiency and reflux effect. Further, dispersion of monomers also increased. The aromatic polyester produced had a deteriorated heat resistance, color tone, and viscosity.

### DESCRIPTION OF SYMBOLS

1: Reactor
2: Heating medium jacket for heating
3: Stirring blade
4: Rectifying column
5: Distillation pipe
6: Liquid returning pipe
7: Distillation pipe from rectifying column
8: Condenser (total condenser)
9: Charge port
10: Discharge port
11: Gas (nitrogen) supply port
12: Three-way valve

1.-5. (canceled)

6. An apparatus for producing an aromatic polyester, comprising a reactor, a rectifying column, a distillation pipe for feeding distillate gas from said reactor to said rectifying column, and a liquid returning pipe for returning reflux liquid from said rectifying column to said reactor, wherein the ratio of (b) the inside diameter of pipe of said liquid returning pipe to (a) the maximum inside diameter of drum of said reactor, (b)/(a), is 0.012 to 0.12.

7. The apparatus for producing an aromatic polyester according to claim 6, wherein the ratio of (c) the inside diameter of pipe of said distillation pipe to (b) the inside diameter of pipe of said liquid returning pipe, (c)/(b), is 1.1 or more.

8. The apparatus for producing an aromatic polyester according to claim 6, wherein said rectifying column is an internal reflux column that exteriorly has a jacket through which refrigerant passes and is selected from a single tube equipped with a baffle plate, a packed column, and a tray column.

9. The apparatus for producing an aromatic polyester according to claim 6, wherein the ratio of (c) the inside diameter of pipe of said distillation pipe to (b) the inside diameter of pipe of said liquid returning pipe, (c)/(b), is 1.1 or more, and,
said rectifying column is an internal reflux column that exteriorly has a jacket through which refrigerant passes and is selected from a single tube equipped with a baffle plate, a packed column, and a tray column.

10. The apparatus for producing an aromatic polyester according to claim 6, wherein original monomers of the aromatic polyester are at least one selected from the group consisting of aromatic hydroxycarboxylic acids, aromatic dicarboxylic acids, and aromatic dihydroxy compounds.

11. The apparatus for producing an aromatic polyester according to claim 6, wherein the ratio of (c) the inside diameter of pipe of said distillation pipe to (b) the inside diameter of pipe of said liquid returning pipe, (c)/(b), is 1.1 or more, and,
original monomers of the aromatic polyester are at least one selected from the group consisting of aromatic hydroxycarboxylic acids, aromatic dicarboxylic acids, and aromatic dihydroxy compounds.

12. The apparatus for producing an aromatic polyester according to claim 6, wherein said rectifying column is an internal reflux column that exteriorly has a jacket through which refrigerant passes and is selected from a single tube equipped with a baffle plate, a packed column, and a tray column, and,
original monomers of the aromatic polyester are at least one selected from the group consisting of aromatic hydroxycarboxylic acids, aromatic dicarboxylic acids, and aromatic dihydroxy compounds.

13. The apparatus for producing an aromatic polyester according to claim 6, wherein the ratio of (c) the inside diameter of pipe of said distillation pipe to (b) the inside diameter of pipe of said liquid returning pipe, (c)/(b), is 1.1 or more;
said rectifying column is an internal reflux column that exteriorly has a jacket through which refrigerant passes and is selected from a single tube equipped with a baffle plate, a packed column, and a tray column; and
original monomers of the aromatic polyester are at least one selected from the group consisting of aromatic hydroxycarboxylic acids, aromatic dicarboxylic acids, and aromatic dihydroxy compounds.

14. A process for producing an aromatic polyester, comprising carrying out an acetylation reaction using the apparatus for producing an aromatic polyester according to claim 6, and then carrying out a polymerization reaction.

15. The process for producing an aromatic polyester according to claim 14, wherein the ratio of (c) the inside diameter of pipe of said distillation pipe to (b) the inside diameter of pipe of said liquid returning pipe, (c)/(b), is 1.1 or more.

16. The process for producing an aromatic polyester according to claim 14, wherein said rectifying column is an internal reflux column that exteriorly has a jacket through which refrigerant passes and is selected from a single tube equipped with a baffle plate, a packed column, and a tray column.

17. The process for producing an aromatic polyester according to claim 14, wherein original monomers of the aromatic polyester are at least one selected from the group consisting of aromatic hydroxycarboxylic acids, aromatic dicarboxylic acids, and aromatic dihydroxy compounds.

18. The process for producing an aromatic polyester according to claim 14, wherein the ratio of (c) the inside diameter of pipe of said distillation pipe to (b) the inside diameter of pipe of said liquid returning pipe, (c)/(b), is 1.1 or more, and,
said rectifying column is an internal reflux column that exteriorly has a jacket through which refrigerant passes and is selected from a single tube equipped with a baffle plate, a packed column, and a tray column.

19. The process for producing an aromatic polyester according to claim 14, wherein the ratio of (c) the inside diameter of pipe of said distillation pipe to (b) the inside diameter of pipe of said liquid returning pipe, (c)/(b), is 1.1 or more, and,
original monomers of the aromatic polyester are at least one selected from the group consisting of aromatic hydroxycarboxylic acids, aromatic dicarboxylic acids, and aromatic dihydroxy compounds.

20. The process for producing an aromatic polyester according to claim 14, wherein said rectifying column is an internal reflux column that exteriorly has a jacket through which refrigerant passes and is selected from a single tube equipped with a baffle plate, a packed column, and a tray column, and,
original monomers of the aromatic polyester are at least one selected from the group consisting of aromatic hydroxycarboxylic acids, aromatic dicarboxylic acids, and aromatic dihydroxy compounds.

21. The process for producing an aromatic polyester according to claim 14, wherein the ratio of (c) the inside diameter of pipe of said distillation pipe to (b) the inside diameter of pipe of said liquid returning pipe, (c)/(b), is 1.1 or more;
said rectifying column is an internal reflux column that exteriorly has a jacket through which refrigerant passes and is selected from a single tube equipped with a baffle plate, a packed column, and a tray column; and
original monomers of the aromatic polyester are at least one selected from the group consisting of aromatic hydroxycarboxylic acids, aromatic dicarboxylic acids, and aromatic dihydroxy compounds.
